(19) United States
(12) Patent Application Publication
(10) Pub. No.: US 2003/0221886 A1
(43) Pub. Date: Dec. 4, 2003

(54) Veritable perimeter cruise control

(76) Inventor: Alfred E. Petrie JR., Menasha, WI (US)

Correspondence Address: Alfred Petrie, 712 Jefferson St., Menasha, WI, 54952, US

(21) Appl. No.: 10/157,528

(22) Filed: May 30, 2002

(51) Int. Cl. B60K 31/00

(52) U.S. Cl. 180/170

(57) ABSTRACT

A device to regulate fuel consumption and speed utilizing a speed range rather than the set firm speed currently in use. Resulting in fuel and energy savings under non-level driving conditions and more closely follows the natural flow of traffic.

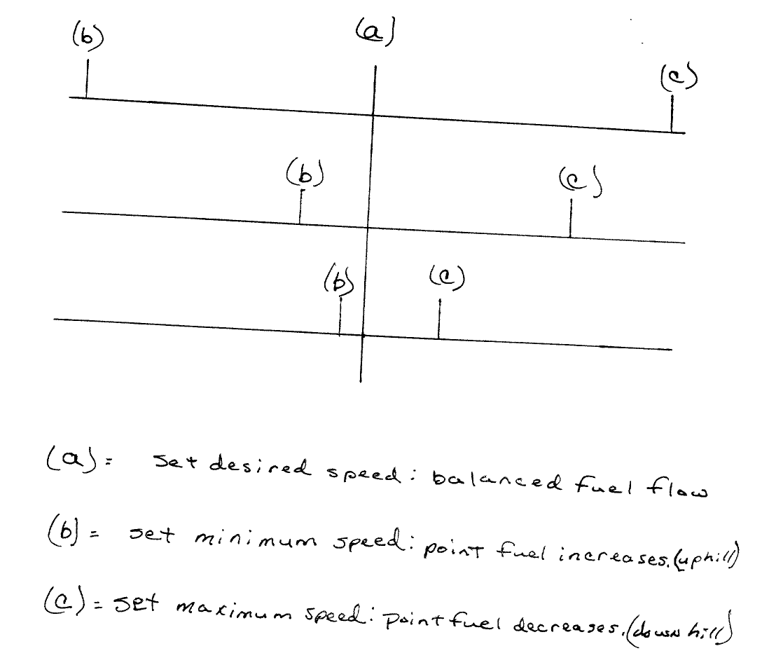

Comprising:

System to identify most favorable conditions for acceleration of speed which signals for reactions from vehicles fuel supply ranging from increases fuel flow under marginally favorable conditions to reducing fuel flow under most favorable conditions such as a steep downhill with the assistance of a level sensing device.

A like system that operates by the natural action of a current curse control recognizing multiple calls for fuel increase to indicate an uphill condition and multiple reductions in fuel flow indicating a downhill situation delaying reductions until reaching the set high speed perimeter. Added to either approach a mechanism triggered by a switch for gradual reduction in speed used in anticipation of a stop or reduction of speed.

### BACKGROUND

1. Field of Invention

This invention relates to the manner in which current and past motor vehicle cruse controls operate.

2. Description of prior art

The evolution of automotive cruse controls has been and remains fixed on maintaining a certain fixed speed. In a head wind dust or uphill they pour on more fuel. Down hill they reduce fuel or even automatically downshift or break somewhat to stop gained speed when this speed is essentially free.

While these cruise controls have become very nice they have maintained two negative ramifications in their operation. They waste fuel and do not follow the natural flow of traffic.

### SUMMARY

In accordance with present cruse controls they stop gained speed downhill and pour on the fuel uphill.

My version of this cruise control would encourage gained speed downhill and somewhat coasting uphill, more closely matching the natural flow of traffic and saving fuel under non-flat driving conditions.

### DESCRIPTION

Physically, my veritable perimeter cruse control would resemble current models with the addition of switches for settable perimeters and deceleration mode.

My version would resemble current cruise controls actions under flat driving conditions but differ by encouraging gained speed downhill and lost speed uphill. A settable speed range both above and below the cruse controls flat or level driving set speed.

### OPERATION

My veritable perimeter cruse control is designed to take advantage of uneven driving surfaces by not maintaining a certain speed but rather a speed range.

Traditional cruse controls upon engagement either reduce or increase the fuel supply to establish that speed. Once the speed is established it increases and decreases back and forth in small increments to maintain that speed.

My variable perimeter cruse control differs than that traditional cruse control in that after the vehicle's speed is established, it will detect a plurality of:

a. Consecutive decreases of fuel flow to indicate a reduced load such as when traveling downhill, delaying reduction in fuel flow until the vehicle reaches it's set top speed or returns to the set median speed.

b. Consecutive increases of fuel flow to indicate an increased load such as uphill or headwind gusts delaying increases in fuel flow until the vehicle reaches it set minimum speed or returns to the median speed. There would an aspirate fuel flow reduction upon reaching set top speed and a increase upon reaching set minimum speed.

### DESCRIPTION AND OPERATION (ALTERNATIVE EMBODIMENTS)

In the best mode or preferred embodiment my veritable perimeter cruse control would be augmented by a system that would recognize and react to supply fuel in a manner to most effectively supply speed with minimum overall fuel consumption.

This system would vary the fuel supply while traveling downhill using only as much fuel as necessary to gain speed. An example of this would range from an idle engine type supply on steeper grades or downhill's to actually increasing fuel supply in very minor downhill's allowing the vehicle to gain speed while the conditions are most favorable for speed gain.

This system would be augmented by, but not limited to, an instantaneous gas mileage computation and or an altitude or angle sensing device and or the possible use of radar or device to detect whether the road in front of the vehicle is going up or downhill (may be similar to automatic distance setters on cameras).

### Conclusion, Ramifications, and Scope

Thus the reader should understand that my variable perimeter cruse controls would maximize fuel efficiency and the overall expenditure of energy where it now suffers most. Hilly non-level roadways are cited in most motor vehicles owners manuals as resulting in significantly reduced mileage ratings.

A very basic example of this principle of it's operation is in something we have all done. Pushing a heavy wheeled object. The advantage of picking up some speed before going uphill often made an otherwise impossible job possible and much easier.

Simply stated expend the least amount of energy for the highest overall speed ratio.

Alternatively this veritable perimeter curse control should not be limited to hold the fixed rate of fuel supply a much more efficient balance might; such as indicated in alternative embodiments. An additional function added to this fuel management system would be a slow fade out of the fuel supply trigged the driver's anticipation of an impending stop or reduction in speed limit a distance ahead.

1. A method of reducing motor vehicle fuel consumption while traveling over hills and grades with vehicles cruse control engaged utilizing a settable speed and speed range establishing a perimeter around said set speed with a device to indicate and signal vehicles fuel system to adjust fuel flow for an optimum overall performance in fuel mileage within set perimeters with fuel flow adjustments ranging from;
a. Increases in fuel supply while traveling down a very mild downhill to decreasing fuel to an idle type supply in the case of a downhill adequate to still gain speed and as approximate in-between,
b. Delaying fuel increases while traveling uphill until reaching set bottom speed perimeter,
c. Integrated into system an operator activated gradual fuel reduction.
